(19) United States
(12) Patent Application Publication
(10) Pub. No.: US 2016/0357530 A1
(43) Pub. Date: Dec. 8, 2016

(54) METHOD AND APPARATUS FOR INTERMEDIATE REPRESENTATION OF APPLICATIONS

(71) Applicant: Apple Inc., Cupertino, CA (US)

(72) Inventors: Evan Cheng, Hillsborough, CA (US); Robert P. Wilson, Palo Alto, CA (US); Christopher Arthur Lattner, Los Gatos, CA (US); James Henry Grosbach, San Jose, CA (US); Nick Kledzik, Cupertino, CA (US); Shengzhao Wu, Cupertino, CA (US)

(21) Appl. No.: 14/732,604

(22) Filed: Jun. 5, 2015

(51) Int. Cl. G06F 9/45

(52) U.S. Cl. CPC G06F 8/44; G06F 8/52

(57) ABSTRACT

A method and an apparatus for application submission and distribution based on an intermediate code are described. The intermediate code may be received at a server device and stored in a data storage. The intermediate code may have been built from a source code. The intermediate code may include one or more build options applied for building an executable code from the source code. The executable code may be provided to target devices of a processor platform to perform data processing operations specified in the source code. In one embodiment, a particular executable code may be generated from the intermediate code at the server device to target a particular processor platform according to the build options embedded in the intermediate code. The particular executable code may be forwarded to a device requesting for an application corresponding to the particular executable code to perform the data processing operations.

### FIELD OF INVENTION

The present invention relates generally to application development. More particularly, this invention relates to building and distributing application executables based on an intermediate representation of an application.

### BACKGROUND

Retail applications submitted to a market place, such as an application store, are typically packages of fully compiled binary executables for user devices to purchase and/or download. A binary executable may be built targeting a specific type of devices, for example, based on a family of processors or hardware features. Usually, the applications are built to support most popular types of user devices.

However, with the fast advancement in device technologies, increasing number of different types or variations of devices continue to appear in the market. As a result, developers may spend significant amount of resources to support the ever changing types of devices targeted. For example, each binary executable may need to be rebuilt to support even small variations of hardware features or system properties of the targeted devices.

Although techniques such as virtual machines can run a common code to support different types of devices, however, running virtual machine based code may suffer performance tradeoff compared with running natively compiled binary code. Further, requirements for user device to install virtual machine systems may not be practically feasible.

Therefore, traditional mechanisms for application submission and distribution may be inefficient, ineffective and costly.

### SUMMARY OF THE DESCRIPTION

An application in intermediate code representation (or intermediate format) may be built on a developer device. For example, the intermediate code may be based on bitcode for a compiler infrastructure named LLVM. A compiler may produce the intermediate code when compiling the source code of the application. The application represented by the intermediate code may be submitted to an application store (e.g. application server). Executables of the application may be later rebuilt from the intermediate code targeting multiple client devices which have different processing platforms.

In one embodiment, a compiled code may be generated at a first device for a target device from a source code specifying data processing operations. The compiled code may include executable code and intermediate code. The executable code may be targeted to be executable on devices of a processing (or processor) platform of the target device to perform the data processing operation. The intermediate code may be sent to a second device (which can be part of an application store) remotely coupled to the first device without sending the source code and the executable code to the second device. A plurality of executable codes targeting a plurality of processor platforms can be generated from the intermediate code. Each executable code may perform the data processing operations specified in the source code which is hidden from the intermediate code.

In one embodiment, the second device does not receive the source code so that the developer can preserver the trade secrecy of the source code while also allowing the application store to generate different (target device specific) executables from the intermediate code. For example, the intermediate code may include symbols obfuscated from the source code. Mapping data may be required to relate the symbols in the intermediate code and information of the source code. Both the mapping data and the symbols may be needed to generate debug information for bug reporting.

In another embodiment, an intermediate code received at a server device may be stored in a data storage associated with the server device. The intermediate code may have been generated or built from a source code. The intermediate code may include or embed one or more build options applied for building an executable code from the source code. The executable code may be provided to target devices of a processor platform to perform data processing operations specified in the source code. In one embodiment, a particular executable code may be generated from the intermediate code at the server device to target a particular processor platform according to the build options embedded in the intermediate code. The particular executable code may be forwarded to a device requesting an application corresponding to the particular executable code (for that device) to perform the data processing operations.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating an embodiment of distributing applications submitted based on intermediate representations;

FIG. 2 is a block diagram illustrating a system to build applications represented by intermediate code;

FIG. 3 illustrates one example of an application represented in a package of intermediate code collected from object code compiled for the application;

FIG. 4 is a block diagram illustrating a system to rebuild applications from intermediate code representations;

FIG. 5 is a flow diagram illustrating one embodiment of a process to build an application represented by intermediate code;

FIG. 6 is a flow diagram illustrating one embodiment of a process to rebuild an application from intermediate code representations;

FIG. 7 illustrates one example of a data processing system such as a computer system, which may be used in conjunction with the embodiments described herein.

### DETAILED DESCRIPTION

Methods and apparatuses for applications represented in intermediate code format are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment. Further, specific numeric references such as first, second, third, etc., may be made. However, the specific numeric references should not be interpreted as a literal sequential order but rather interpreted as references to different objects.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

An intermediate code represented application (or in intermediate format) can allow an application to be submitted to an application store for distribution (e.g. through downloads from an application store) without submitting fully compiled binary code (e.g. executables with machine instructions). The intermediate code may be produced at the same time when building an application executable from source code of the application.

For example, the intermediate code representing the application may be generated during early phases (e.g. source code compilation) of application building. The application store may perform later phases (e.g. code linking) of the application building or rebuilding based on the intermediate code with added freedom to translate an application executable from one target processor platform to another target processor platform. Thus, an application developer can build an executable of an application for a testing device. An intermediate format of the application can be automatically generated when building the executable. This intermediate format of the application may be submitted for building different executables for target devices not known to the developer.

Target devices may differ in associated processor platforms. A processor platform may represent a hardware infrastructure for a device, such as a mobile computer, a desktop computer or other data processing device. For example, processor platforms may differ in types of technologies, such as wireless chipset, processor, southbridge, northbridge, or other applicable hardware components etc. included in the device. In one embodiment, the intermediate code may allow an application server to build separate application executables for a 32-bit processor and a 64-bit processor. A device can download from the application store an application executable built (or rebuilt) for the processor platform of this device from the intermediate code.

In an embodiment, the intermediate code may be based on a low level abstraction of actual machine code. An instruction of the intermediate code may represent multiple operations specified in actual machine code instructions. For example, unlimited number of registers may be referenced in a bitcode while only a limited number of actual registers may be available in a binary machine code translated from the bitcode. Data layout alignment in the memory may be realigned to support transition from 32-bit to 64-bit processor. One intermediate code based on bitcode may be translated into multiple binary executable codes, each targeting a different processor platform which may or may not exist at the time this intermediate code was produced.

According to certain embodiments, bitcode based intermediate code representations may be hybrid in nature to target a limited (or selected) range of processor platforms (instead of targeting all or any possible processor platforms). Multiple programming languages may be supported to generate the intermediate code (i.e. not tied to a specific programming language). An application can be rebuilt for different processor platforms within the range as if natively compiled/linked from the original source code without performance comprises (e.g. without loss of performance) and without revealing intellectual properties described in the source code.

Processor platforms may differ in versions of a processor family, versions of system components, processor architectures (e.g. 32-bit processor vs. 64-bit processor), processor instruction sets, or other applicable platform differences. The intermediate code can capture the essence of an application for different processor platforms without requiring an application developer to provide the source code. A user device of a new processor platform can download an application built from the intermediate code as true native code (i.e. not an emulate code) as if the developer rebuilt (e.g. recompiled/linked) the downloaded application specific for the user device from the source code.

In one embodiment, application building from a source code to a machine code or application executable may include a pipeline of build steps or processing with a variety of build options, such as compiler options, linker options etc. The intermediate code may be based on intermediate representation of code available along the pipeline before the machine code is generated. The intermediate code may include all information (e.g. build options) necessary to replay the pipeline of processing from the intermediate code (e.g. to get the same results as the originally generated machine code). In some embodiments, the intermediate code may be extracted from a result of the pipeline processing by stripping executable code sections (e.g. text and data sections) and leaving the intermediate code (e.g. bitcode) section.

Thus, intermediate code based representation of applications can allow developers to follow a new device road map automatically without a need to be aware of different target platforms. Application submission system based on intermediate code representation can distribute applications with the flexibility to support new device hardware automatically without involvement of the developer and/or end users of the application rebuilding work.

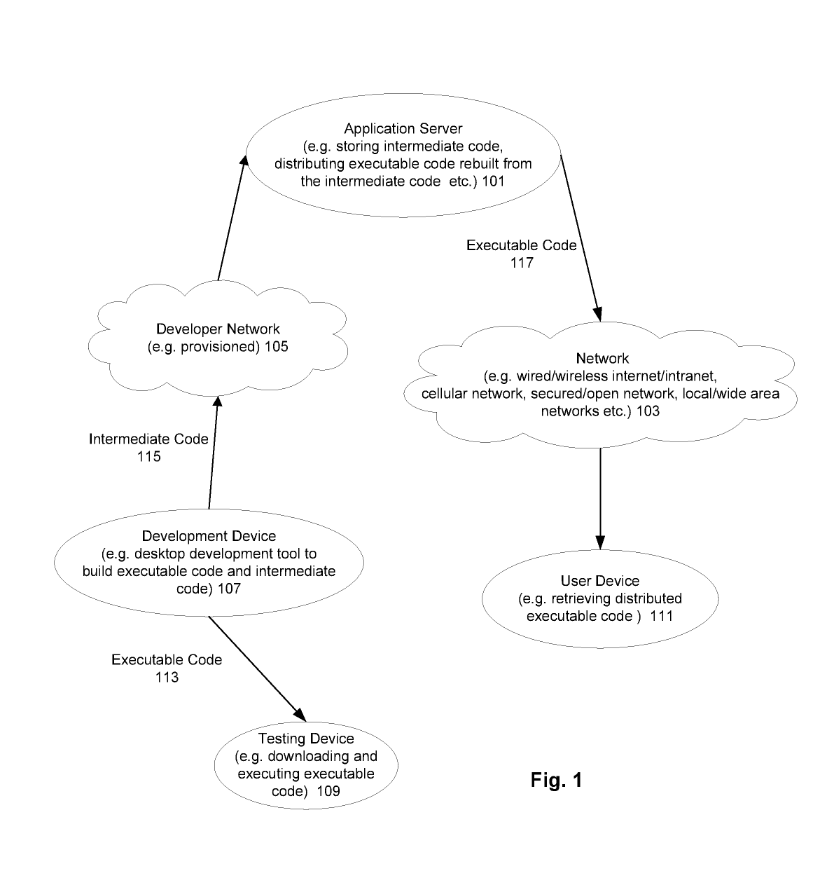

FIG. 1 is a block diagram illustrating an embodiment of distributing applications submitted based on intermediate representations. For example, an application may be developed in a development device 107 by developer(s). Development device 107 may include desktop computers, workstations or other applicable standalone or networked data processing machines providing development environments or tools. Developer(s) may use these tools to write/edit source codes and develop the application.

For example, source codes of an application may be translated (e.g. compiled, linked, optimized or processed) into executable code 113 and intermediate code 115 via the development tools. Executable code 113 may include binary machine instructions targeting processor platform of testing device 109, such as a mobile device or a phone device for installing and running the application. Executable code may bundle resources (e.g. images, screen files, sound files, user interface designs or other application data) needed in the application. Device 109 may be coupled (locally or remotely) with development device 107 to download and execute executable code 113 for testing the application.

In one embodiment, intermediate code 115 may be provided automatically (or on demand) with executable code 113 via a development environment in development device 107. Intermediate code 115 may include an abstract intermediate representation of the application. The abstract intermediate representation may include about the same (low) level of data processing specifications as in machine code compiled from the corresponding source code of the application. Thus, the abstract intermediate representation can provide a level of protection from exposing the source code. Intermediate code 115 may include resources required to build the application.

Intermediate code 115 may be submitted to application server 101 for distribution when the development of the application completes. In one embodiment, application developers can submit the intermediate code to server 101 without ever providing the source code used to create the intermediate code to server 101 so that the trade secrecy of the source code can be preserved. Application server 101 may function as a middle man service (such as an application store or app store) connecting applications developed by multiple developers with multiple end users. In one embodiment, application server 101 may be coupled with development device 107 via developer network 105 which may be provisioned (e.g. protected via passwords or other registration mechanisms).

Application server 101 may certify and store intermediate code 115 in a storage. For example, a signed certification can ensure that intermediate code 115 has not been modified or tampered with during the transfer from development device 107 to application server 101. Intermediate code 115 may include cryptographic code signature for the verification that contents of intermediate code 115 are not modified during transmission over developer network 105.

Binary executables of the same application targeting devices of different processor platforms (which may or may not exist at the time of submission of intermediate code 115) may be rebuilt from intermediate code 115 stored in application server 101. For example, executable code 117 may be rebuilt from intermediate code 115 for a processor platform of user device 111. In one embodiment, application server 101 may pre-build and store multiple executables of the same application, each targeting a different processor platform of user devices. When a user device requests a particular software product (an application or app), the user device can specify a device type, device class or other identifiers so that the application store can select the appropriate executable that is compatible to run on that specific device.

User device 111 can perform purchasing transactions with application server 101 via network 103 to download and install an application executable. Network 103 may include wired/wireless internet/intranet, cellular network, secured/open network, local/wide area networks, or other applicable data exchanges mechanisms. Application server 101 may identify and distribute executable code 117 compatible with the hardware platform or configuration of user device 111.

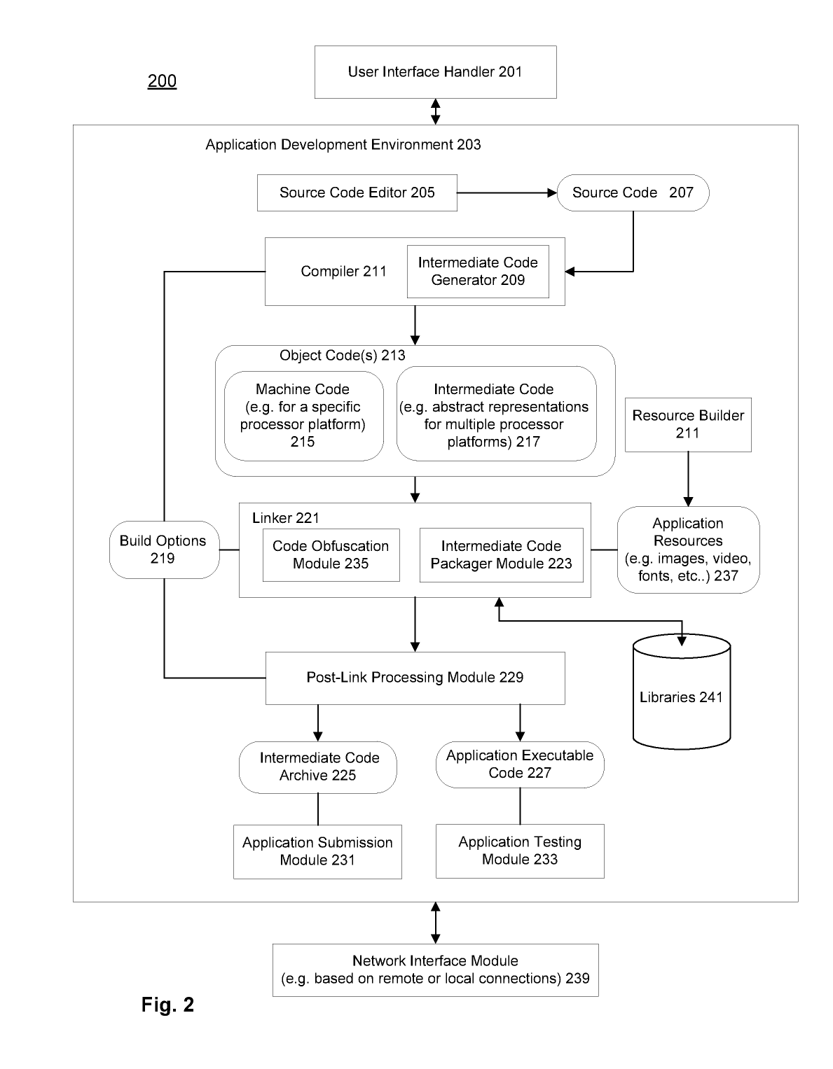

FIG. 2 is a block diagram illustrating a system to build applications represented by intermediate code. For example, development device 107 of FIG. 1 may include some components of system 200 of FIG. 2. In one embodiment, application development environment 203 may provide an integrated development environment running in an operating system of a developer's machine, such as development device 107 of FIG. 1. Application development environment 203 may be coupled with user interface handler 201 to allow a developer to create/edit/update source code 207 via source code editor 205 for building an application. Application development environment 203 may support applications developed for user devices of various form factors, such as wearable devices (e.g. watches), phone devices, television devices, mobile devices or other applicable user devices.

In one embodiment, compiler 211 can compile source code 207 into object code 213 based on build options 219 which can store command line options used or pre-specified for application building in application development environment 203. Source code 207 may include one or more source files specified in a programming language. Each source file may be compiled into one corresponding object file of machine code 215 and/or intermediate code file of intermediate code 217. Different source files may include code written in different or the same programming languages, such as C, C++, Objective-C, Swift or other applicable programming languages. Object code 213 may be compiled compiler commands with compiler options. Compiler options may indicate level of optimization, whether to generate intermediate representation or other application code translation options.

In one embodiment, compiler 211 may include intermediate code generator 209. Object code 213 may include machine code 215 having machine instructions executable in a specific target processor platform of a device, such as a testing device used by a developer. Alternatively or optionally, object code 213 may include intermediate code 217 generated via intermediate code generator 209 which is activated during compilation of compiler 211 or independently invoked through compilation commands. Intermediate code 217 may include abstract representations of machine instructions which can be retargeted to actual machine instructions for different processor platforms. In one embodiment, compiler options used to generate machine code 215 may be recorded, e.g. according to build option 219, to allow replay of the compilation using intermediate code 217 instead of source code 207. Compiler options may be recorded in a corresponding intermediate code file for each source code file.

In one embodiment, compiler 211 may split into two or more processes when invoked with build options to embed or generate intermediate code. For example, compiler 211 may include a normal compilation process which may stop before actual machine code generation after running IR (intermediate representation) level optimization when compiling a source code. Subsequently a second process may be invoked (e.g. based on intermediate code generator 209) to embed a copy of its own intermediate code or bitcode input as raw data in a separate section of object code 213 and then proceed with code generation. Note that code generation is performed in a separate process to match the behavior of application rebuilding based on the intermediate code at an application server, such as application server 101 of FIG. 1, as closely as possible.

Compiler code generation may be affected by various command-line options, such as build options including compiler options, which may differ for each compilation. These compiler options may be recorded in the intermediate code itself. The recorded compiler options may be used for link time optimization, e.g. via linker 221. Relevant command-line options for compilation (e.g. for rebuilding an application using intermediate code) may be embedded in a separate section in object code 213. For example, build options 219 may include a compilation option that specifies the level of optimization to be performed. In some embodiments, compilation options may be selectable via a white-list for build options 219 to specify which compilation options are relevant (or all compilation options are relevant). For example, compiler options which specify an overall optimization level may or may not be recorded.

Linker 221 may combine one or more object files in object code 213 with library 241 into a library file, another object file or a single executable file, such as application executable code 227. Linker 221 may be invoked with linker options which may be recorded in build options 219. In one embodiment, Linker 221 may support a intermediate code or bitcode option to specify that it should collect the intermediate code and compiler options embedded by compiler 211 in the object files and generate an archive file, such as intermediate code archive 225 as an output in addition to application executable code 227.

In one embodiment, linker 221 may embed intermediate code archive 225 as a section within application executable code 227. As a result, the need to keep track of separate archive files may be avoided. Other software that interacts with application executable code 227 may not need to know anything about intermediate code archive 225.

Linker options may allow full control on where the archive file is placed in a file system associated with application developer environment 203. In one embodiment, intermediate code package module 223 may extract or collect intermediate code files and associated compiler options from object code and package or archive them into intermediate code archive 225. A table of contents may be created within intermediate code archive 225 to list intermediate code files collected.

According to certain embodiments, possible linker options may be automatically filtered or limited when linker 221 is invoked to generate an archive file of intermediate code, such as intermediate code archive 225. The scope of allowed linker options with an intermediate code may be based on whether matching linking operations can be performed in rebuilding a corresponding executable based on the intermediate code in an application server, such as application server 101 of FIG. 1. For example, a white-list of supported linker options may be configured for linker 221 when invoked to generate intermediate code archive 225. Linker 221 may report an error if a developer attempts to use any linker options not included in the white-list when linker 221 is specified (e.g. with a special linker option) to generate intermediate code.

In some embodiments, linker 221 may record in intermediate code archive 225 a flat list of object code files and/or library files (e.g. in libraries 241) to be linked together. An application server may link object files in the order specified in the recorded flat list to rebuild the application. Additional or optional items recorded, e.g. via a header section, in intermediate code archive 225 may include the command-line options used for the link, unique identifiers for symbol files to generate debug information, library dependencies for specifying linking order of local libraries, and/or other applicable options.

In some embodiments, linker 221 may support an option to perform a relocatable link. One or more object file (or object code file) inputs may be combined to produce a single relocatable object file in a relocatable link. The resulting object file (e.g. relocatable object file) may then be used in subsequent linking steps. Furthermore, each linking operation (or step) may be performed with different (e.g. link) options. In some embodiments, the intermediate code archive can record (e.g. include a description) of an hierarchical structure of these object files (or object code files), for example, in addition to a flat list of these object files, along with the link options to be used at each linking step.

In some embodiments, linker 221 may not embed intermediate code files of libraries (e.g. libraries 241) into intermediate code archive 225. Instead, intermediate code archive 225 may include specifications of these static libraries to allow a linker at an application server to link with correct versions (e.g. matching version or more recent versions) of corresponding static libraries when rebuilding the application from the intermediate code.

According to certain embodiments, linker 221 may detect whether an object file is embedded with an intermediate code file. Linker 221 may allow mixing an object file or assembly file without a corresponding intermediate file with other intermediate code files in intermediate code archive 225. Linker 221 may prohibit mixing an assembly file of a third party library (e.g. not build from source code 207) in intermediate code archive 225. Alternatively or optionally, linker 221 may report an error when an object code file without embedding a corresponding intermediate code file is detected.

Application development environment may include resource builder 243 to allow a developer to generate application resources 237 to be used to run an application. Application resources 237 may include media data, images, videos, sound files, user inter face designs tailored for different display resolutions, or other applicable application assets. Intermediate code archive module 223 may embed application resources 237 into intermediate code archive 225. Application executable code 227 may include application resources 237 to be installed in a test device.

In some embodiments, code obfuscation module 235 may obfuscate (e.g. obscurely rename or rearrange) symbols in the intermediate code, e.g. included in intermediate code archive 225. The meaning or function of obfuscated symbols may become obscure to comprehend for security or privacy protection. For example, software developers often want to maintain their source code as a trade secret to prevent competitors from using the code, implementations or methods in the source code. This obfuscation module 235 can provide at least some obfuscation to the intermediate code, thereby helping to preserver the trade secrets of the source code.

Different types of symbols may be identified from object code files via linker 221. For example, symbols in object code 213 may include interface symbols defining API (application programming interfaces) to frameworks (e.g. libraries) or interfaces across object code files. Object code 213 may include debug symbols related to source code information (or names) on variables, types, values, types, function parameters, associations with source code line numbers, etc. Code obfuscation module 235 may selectively perform symbol obfuscations. For example, interface symbols may be hidden but not obfuscated and exported. Debug symbols may be optionally obfuscated without meaningful names and/or stripped according to user settings or project settings which can be configurable in application development environment 203.

Post-link processing module 229 may be invoked to perform build steps after linking operations performed by linker 221. For example, post-link processing module 229 may add entitlement information (e.g. for entitlement property list) to intermediate code archive 225. Post-link processing module 229 may perform binary code processing operations on application executable code 227. Binary code processing operations may include updating debug information in object files using debug symbols in symbol tables, stripping binary content included in an application executable (e.g. to remove application resources which are not used in targeted devices), stripping symbols (e.g. related to debug information) from an application executable etc.

In one embodiment, application development environment 203 may include project settings which control binary code processing operations to be performed. Post-link processing module 229 may record these project settings into intermediate code archive 225 to allow matching operations to be performed for rebuilding the application from intermediate code archive 225 in an application server.

In some embodiments, intermediate code archive 225 may be generated automatically or substantially simultaneously when application executable code 227 is generated for testing/building an application. Application testing module 233 may be invoked for a testing device to download and install application executable code 227 via network interface module 239. Once application development is complete, application submission module 231 can submit or send intermediate code archive 225 to an application server (which can be a testing application server or a store application server) for distribution to devices of different processor platforms. Application submission via application submission module 231 may include all information (such as libraries referenced, dependencies among the libraries etc.) necessary to translate an intermediate code to a real executable.

In some embodiments, application submission module 231 may search through a payload directory (e.g. produced for building application executable code 227) for executables and/or library (e.g. dynamic library) binaries identified by unique identifiers (e.g. universally unique identifiers) to correlate these binaries with various intermediate code files (e.g. archive files representing an executable or a library) generated during the build. These intermediate code files (e.g. archive files) may be copied (e.g. via application submission module 231) into a intermediate code directory (e.g. bitcode directory) of a submission package (e.g. including intermediate code archive 225) along with a property list file that records the install path for each binary (e.g. an executable or a library for an application).

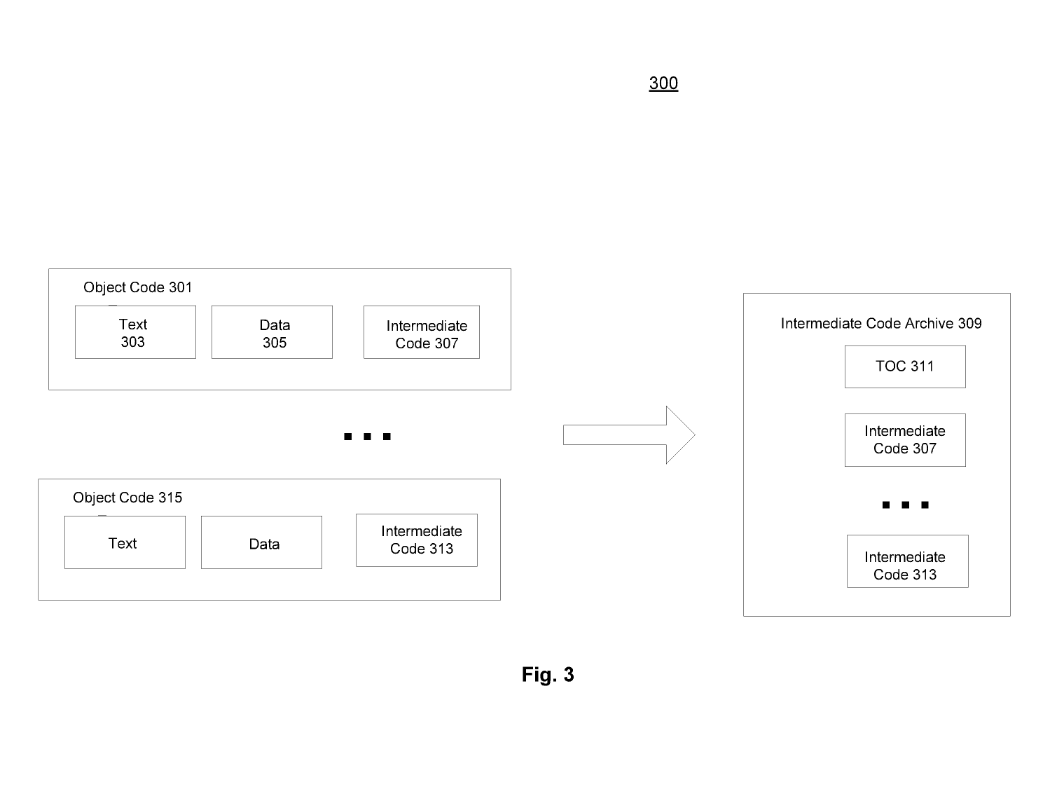

FIG. 3 illustrates one example of an application represented in a package of intermediate code collected from object code compiled for the application. Example 300 may include object code 301, 315 representing object code files compiled from source code files via a compiler, such as compiler 211 of FIG. 2. Object code 301 can have multiple sections, such as text 303, data 305 and intermediate code 307. Text 303 and data 305 may specify machine code or assembly code, such as in machine code 215 of FIG. 2. Intermediate code 307 may include intermediate representation of machine instructions, such as in intermediate code 217 of FIG. 2.

Intermediate code archive 309 may include application intermediate code collected from multiple object code files, such as object code 301, 315. For example, intermediate code archive 309 may include intermediate code archives generated via linker 221 and/or post-link processing module 229 of FIG. 2. In one embodiment, intermediate code archive 309 may be formatted as a collection of intermediate code or bitcode in a same or similar manner as an application executable. For example, intermediate code archive 309 can include TOC (table of content) 311 listing intermediate code 307, 313 collected from object code 301, 315. TOC 311 may include information related to application build process (e.g. build options) recorded for replaying the build process. The intermediate code may be attached to object code files and/or packaged similarly as an application executable to avoid impacting existing executable code based application development flows for developers.

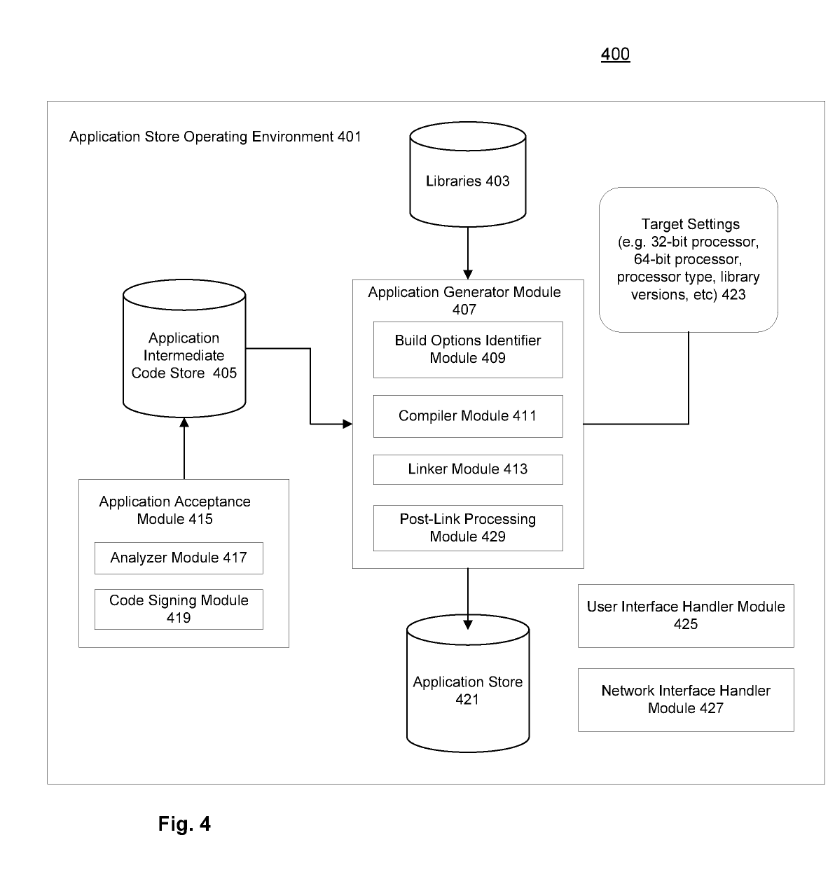

FIG. 4 is a block diagram illustrating a system to rebuild applications from intermediate code representations. For example, system 400 may be hosted via application server 101 of FIG. 1. In one embodiment, application store operating environment 401 may include application intermediate code store 405 which may be based on a database or data storage devices locally or remotely coupled with an application server. Application intermediate code submitted from development devices, such as device 107 of FIG. 1, may be stored in application intermediate code store 405 before corresponding application executables are rebuilt from the stored application intermediate code.

Application acceptance module 415 may receive submission of application intermediate code via network interface module 427. Analyzer module 417 may determine whether to reject or accept the submitted application intermediate code. For example, analyzer module 417 can reject acceptance of application submission based on presence of malicious code, illegal contents (e.g. pornographic content), or unauthorized system interfaces (e.g. private system APIs), etc. The application intermediate code submitted may be approved via analyzer module 417 and/or human review via user interface handler module 425. Code signing module 419 may sign a certificate to an approved application intermediate code.

Application generator module 407 can rebuild multiple application executables from one application intermediate code of an application, e.g. retrieved from application intermediate code store 405. Each application executable may be rebuilt to target devices of a different processor platform for the application. Target processor platforms may be selected based on target settings 423 specifying information regarding configurations of devices for installing the application.

In one embodiment, application generator module 407 may invoke build tools to read a property list of archive files included in an application intermediate code (or package), identify dependency relationships among the archive files and sort the archive files based on the dependency relationships. The build tools may rebuild binaries for different processor platforms by repeating the same or similar pipeline of building steps (e.g. compile, link and post-link build steps) that were used to build the application in a development environment, such as application development environment 203 of FIG. 2.

For example, build options identifier module 409 may read build options recorded in application intermediate code for replaying the pipeline of building steps. In one embodiment, compiler module 411 may compile an intermediate code to object code of targeted processor platform based on compiler options included in the build options. Linker module 413 can perform linking operations on the compiled object code and/or libraries 403 using linking options included in the build options generate a binary code (e.g. executable or library) of the targeted processor platform. Post-link processing module 429 may repeat post link build operations based on project settings recorded in the build options.

In some embodiments, application generator module 407 may support parallel execution of the application building (or rebuilding) steps. The resulting binaries may then be copied into an application payload directory. Optionally or alternatively, symbol file and/or debug information embedded in the application intermediate code may be identified and extracted to support, for example, generating crash log reports in an application server, (e.g. via application store operating environment 401).

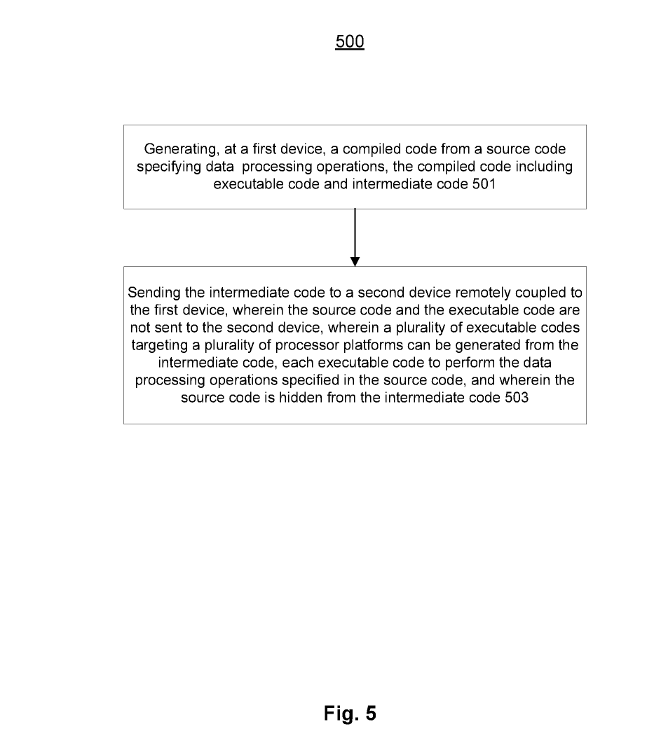

FIG. 5 is a flow diagram illustrating one embodiment of a process to build an application represented by intermediate code. Exemplary process 500 may be performed by a processing logic, including, for example, some components of system 200 of FIG. 2. At block 501, the processing logic of process 500 can generate a compiled code at a first device, such as development device 107 of FIG. 1, from a source code specifying data processing operations, such as source code 207 of FIG. 2. The compiled code, such as object code 213 of FIG. 2, can include executable code and intermediate code.

The processing logic of process 500 can send the executable code to a testing device, such as testing device 109 of FIG. 1, coupled to the first device. The testing device may be configured based on a processor platform. The executable code can include machine instructions executable in devices of the processor platform of the testing device to perform the data processing operation.

In one embodiment, the source code can include one or more source file or source code files. The processing logic of process 500 can compile each source file for the processor platform with one or more compilation options for generating the object file or object code file of the compiled code. Each object file may include machine instructions of the processor platform, e.g. via a compiler associated with the processor platform.

Each object file may include an intermediate code section carrying intermediate representations of machine instructions or abstraction of machine instructions independent of processor platforms. The intermediate code section may record the compilation options applied to generate the object file. Alternatively or optionally, the compilation options may be recorded as build options, such as build option 219 of FIG. 2.

The processing logic of process 500 can link compiled object code files compiled from source code files into a binary code, such as application executable code 227. Additionally, the processing logic of process 500 can archive intermediate code files into an archive code, such as intermediate code archive 225 of FIG. 2. The binary code may correspond to an executable or a library with machine instructions executable for the targeted processor platform. The archive code may correspond to an intermediate code for an application.

The processing logic of process 500 can collect intermediate code from intermediate code sections of the compiled object code files into an archive code when performing the linking operations, e.g. via linker 221 of FIG. 2. The objected code files may be linked with one or more link options. The processing logic of process 500 may record the link options applied to generate the archive code during the linking operations. The link options may be recorded in the archive code, via according to build option 219 of FIG. 2.

In one embodiment, the processing logic of process 500 may perform post build operations or post-link operations, e.g. via post-link processing module 229 of FIG. 2, on the binary code generated via linking operations, for example, to add entitlement information and/or for providing debug information in symbol tables. The post build operations may be performed with project settings (e.g. customizable or configurable by developers), e.g. specified in build options 219 of FIG. 2. The processing logic of process 500 may record the project settings in the archive code to be included in the intermediate code for an application.

At block 503, the processing logic of process 500 can send the intermediate code of the application to a second device, such as application server 101 of FIG. 1, remotely coupled to the first device to rebuild the application for a variety of devices of different processor platforms. For example, these processor platforms may include the processor platform of the second device. A specific executable code can be generated from the intermediate code for this processor platform. This specific executable code and the executable code generated together with the intermediate code from the source code at the first device, when executed in a device of the processor platform of the second device, can produce substantially identical results.

In one embodiment, the source code and the executable code generated at the first device may be hidden from (or not sent to) the second device. The application executables can be built from the intermediate code without a need to access the source code. Each application executable rebuilt from the intermediate code can perform data processing operations as specified in the source code. Information related to intellectual properties of the source code can be hidden from the intermediate code and protected from being accessible outside the first device.

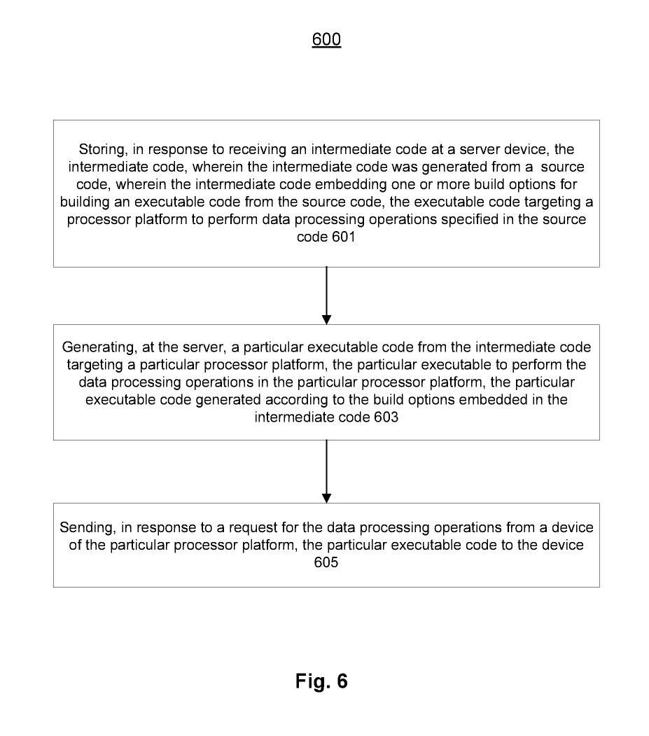

FIG. 6 is a flow diagram illustrating one embodiment of a process to rebuild an application from intermediate code representations. Exemplary process 600 may be performed by a processing logic, including, for example, some components of system 400 of FIG. 4. At block 601, the processing logic of process 600 can store an intermediate code received at a server device, such as application server 101 of FIG. 1. The intermediate code may be generated from a source code outside of the server device and protected from being accessed from the server device.

The intermediate code may be embedded with build options which were previously used for building an executable code from a source code. The executable code may be generated to target a processor platform to perform data processing operations specified in the source code. In one embodiment, the intermediate code may be based on intermediate or abstract representations of machine instructions. For example, the intermediate code may include intermediate instruction sets as bitcode independent of which programming language used in the source code from which the intermediate code was generated.

At block 603, the processing logic of process 600 can generate a particular executable code targeting a particular processor platform. The particular executable may be generated only (e.g. without the corresponding source code) from the intermediate code according to the build options embedded in the intermediate code. The particular executable code may perform the data processing operations in the particular processor platform as specified in the corresponding source code.

The processing logic of process 600 may generate a variety of executables from the intermediate code, each targeting a different processor platform. These executables (e.g. including the particular executable code for the particular processor platform) may be stored in a storage device, such as application store 421 of FIG. 4, before being retrieved for installation in a user device. In one embodiment, a processor platform may specify a bit width of memory address (e.g. 32-bit processor or 64-bit processor). Different executables may be generated for different processor platforms which differ, for example, only in associated bit widths.

In one embodiment, the intermediate code can include a list of one or more portions of intermediate code. Each portion of intermediate code may be extracted as an intermediate code file corresponding to a source code file of the source code. Each intermediate code file may be compiled from a corresponding source file. The processing logic of process 600 can extract the intermediate code files from the intermediate code and identify compilation options from the build options embedded in the intermediate code. The intermediate code files may have been generated or compiled from the corresponding source files based on the compilation options. The processing logic of process 600 may compile the intermediate code files into object code files for at least the particular processor platform based on the compilation options.

The processing logic of process 600 may compile the intermediate code files via one or more compilers to target different processor platforms. The processing logic of process 600 may select a particular compiler from these compilers according to the particular processor platform.

The processing logic of process 600 may link object files compiled from the intermediate files into a binary file for a targeted processor platform according to link options. The processing logic of process 600 can identify these link options from the build options embedded in the intermediate code. An executable may be generated from the binary file. For example, the processing logic of process 600 may perform post-link operations on the binary file to generate the executable code according to one or more post-link options identified from the build options.

In one embodiment, the binary file may include separate application resources designed separately for different processor platforms. These separate application resources may represent a common asset (e.g. same image of different screen resolutions) for running the same application in devices of these different processor platforms.

In some embodiments, the processing logic of process 600 can generate bug (e.g. crash) information for an executable code built from an intermediate code. The bug information may be based on logging data (e.g. crash logs or system information recorded when an application crashes during runtime) reported from user devices. The logging data may include symbols provided in the intermediate code. The symbols may have been obfuscated without exposing intellectual properties included in the corresponding source code.

For example, relationships between the obfuscated symbols and the original source code may be established via a mapping data which may or may not be provided by a developer (e.g. sent from a development device). The bug information may be generated by correlating the logging data and the mapping data. If the mapping data is not available, the debug information may include raw information in the logging data without exposing information of the source code.

At block 605, the processing logic of process 600 can retrieve a particular executable code of an application from an application store, such as application store 421 of FIG. 4, according to a request from a user device for the application. The particular executable code may have been rebuilt from an intermediate code for a particular processor platform of this user device. The processing logic of process 600 can send this particular executable code to the user device to perform data processing operations via the application. According to certain embodiments, the processing logic of process 600 may certify the intermediate code (e.g. with a signed certificate) before storing the intermediate code in a data store, such as application intermediate code store 405 of FIG. 4.

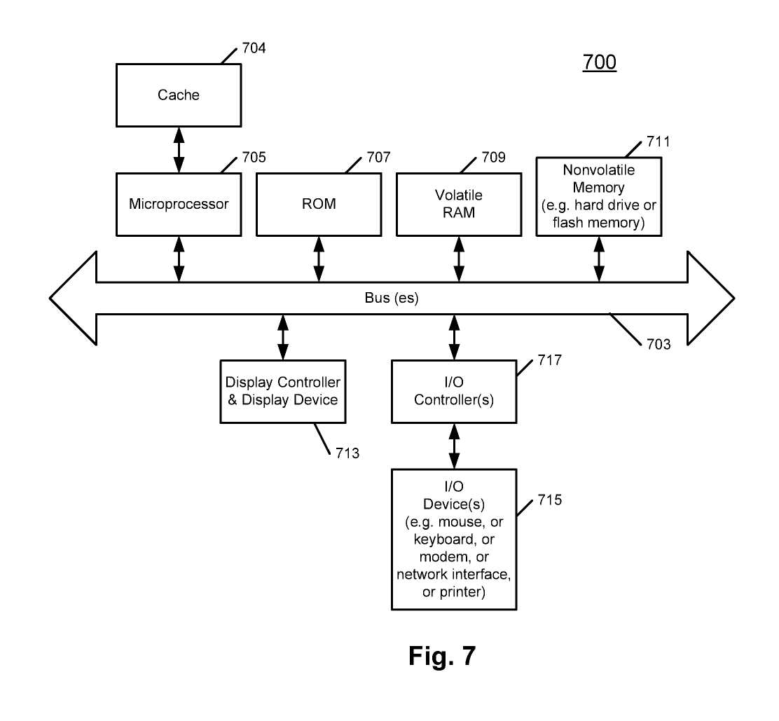

FIG. 7 shows one example of a data processing system, such as a computer system, which may be used with one embodiment of the present invention. For example, system 200 of FIG. 2 and/or system 400 of FIG. 4 may be implemented as a part of the system shown in FIG. 7. Note that while FIG. 7 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 7, the computer system 700, which is a form of a data processing system, includes a bus 703 which is coupled to a microprocessor(s) 705 and a ROM (Read Only Memory) 707 and volatile RAM 709 and a non-volatile memory 711. The microprocessor 705 may retrieve the instructions from the memories 707, 709, 711 and execute the instructions to perform operations described above. The bus 703 interconnects these various components together and also interconnects these components 705, 707, 709, and 711 to a display controller and display device 713 and to peripheral devices such as input/output (I/O) devices which may be mice, keyboards, modems, network interfaces, printers and other devices which are well known in the art. Typically, the input/output devices 715 are coupled to the system through input/output controllers 717. The volatile RAM (Random Access Memory) 709 is typically implemented as dynamic RAM (DRAM) which requires power continually in order to refresh or maintain the data in the memory.

The mass storage 711 is typically a magnetic hard drive or a magnetic optical drive or an optical drive or a DVD RAM or a flash memory or other types of memory systems which maintain data (e.g. large amounts of data) even after power is removed from the system. Typically, the mass storage 711 will also be a random access memory although this is not required. While FIG. 7 shows that the mass storage 711 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface or wireless networking interface. The bus 703 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link or a network connection).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A machine-readable non-transitory storage medium having instructions therein, which when executed by a machine, cause the machine to perform a method, the method comprising:
generating, at a first device, a compiled code from a source code specifying data processing operations using one or more build options, the compiled code including executable code and intermediate code, wherein the one or more build options are embedded in the intermediate code; and
sending the intermediate code to a second device remotely coupled to the first device, wherein the source code and the executable code are not sent to the second device, wherein a plurality of executable codes targeting a plurality of processor platforms can be generated from the intermediate code using the one or more build options embedded in the intermediate code, each executable code to perform the data processing operations specified in the source code, and wherein the source code is hidden from the intermediate code.

2. The medium of claim 1, further comprising:
sending the executable code to a third device coupled to the first device, the third device based on a processor platform, wherein the executable code is executable in devices of the processor platform to perform the data processing operation.

3. The medium of claim 1, wherein the plurality of processor platforms includes the processor platform and wherein the executable codes include a specific executable code generated from the intermediate code for the processor platform, and wherein the specific executable code and the executable code, when executed in a device of the processor platform, produce identical results.

4. The medium of claim 3, wherein the intermediate code includes symbols obfuscated from the source code, wherein the symbols and information of the source code are related via a mapping data for debugging the source code, further comprising:
receiving logging data based on the symbols in the intermediate code from the second device; and
generating bug information from the logging data and the mapping data.

5. The medium of claim 1, wherein the source code includes one or more source files, and wherein generating the compiled code comprises:
compiling each source file for a processor platform with the one or more build options, wherein an object file is generated from the compilation of the source file, the object file including machine instructions of the processor platform.

6. The medium of claim 5, wherein the object file includes an intermediate code section, the intermediate code section including the one or more build options and intermediate representations of the machine instructions, the intermediate representations being independent of the processor platform.

7. The medium of claim 6, wherein the source code files are compiled into one or more object code files, further comprising:
linking the one or more object code files into a binary code and an archive code,
the binary code corresponding to the executable code for the processor platform and the archive code corresponding to the intermediate code.

8. The medium of claim 7, wherein the archive code is embedded as a data section within the binary code.

9. The medium of claim 7, wherein the linking comprises:
collecting intermediate code sections from the object code files into the archive code, wherein the objected code files are linked with one or more link options and wherein the link options are recorded in the archive code.

10. The medium of claim 7, wherein the object code files have a hierarchical structure, and wherein the archive code includes a record describing the hierarchical structure.

11. The medium of claim 7, further comprising:
performing post build operations on the binary code to generate the executable code, the post build operations are performed via one or more post build options.

12. The medium of claim 11, wherein the post build options are recorded in the archive code to generate the intermediate code.

13. A machine-readable non-transitory storage medium having instructions therein, which when executed by a machine, cause the machine to perform a method, the method comprising:
in response to receiving, at a server device, an intermediate code, storing the intermediate code, wherein the intermediate code and an executable code were previously generated from a source code using one or more build options, that are embedded in the intermediate code, the executable code targeting a processor platform to perform data processing operations specified in the source code;
generating, at the server, a particular executable code from the intermediate code targeting a particular processor platform, the particular executable code to perform the data processing operations in the particular processor platform, the particular executable code generated according to the one or more build options embedded in the intermediate code; and
in response to a request for software to perform the data processing operations from a device of the particular processor platform, sending the particular executable code to the device.

14. The medium of claim 13, wherein the intermediate code includes intermediate instruction sets, wherein the source code is specified in a programming language and wherein the instruction sets are independent of the programming language.

15. The medium of claim 13, wherein a processor platform specifies a bit width of memory address, and wherein at least two of the processor platforms differ in the bit width of memory address.

16. The medium of claim 13, wherein the source code includes one or more source files, wherein the intermediate code includes a list of one or more intermediate code portions for one or more intermediate code files, each intermediate code file corresponding to one of the source files, each intermediate code file compiled from a corresponding source file, wherein the generation of the particular executable code comprises:
extracting the intermediate code files from the intermediate code; and
identifying compilation options from the build options embedded in the intermediate code, the intermediate code files generated from the corresponding source files based on the compilation options.

17. The medium of claim 16, further comprising:
compiling the intermediate code files into object code files for at least the particular processor platform, the compilation based on the compilation options.

18. The medium of claim 17, wherein the intermediate code files can be compiled for a plurality of processor platforms by a plurality of compilers, the processor platforms including the particular platform, the compilers including a particular compiler for the particular processor platform, wherein the compilation comprises:
selecting the particular compiler from the compilers according to the particular processor platform, wherein the compilers include a compiler for the processor platform and wherein the intermediate code files can be compiled for the executable code via the compiler.

19. The medium of claim 17, further comprising:
identifying one or more link options from the one or more build options; and
linking the object code files into a binary file based on the link options, wherein the particular executable code is generated from the binary file.

20. The medium of claim 19, further comprising:
identifying one or more post-link options from the one or more build options; and
performing post-link operations on the binary file based on the post-link options.

21. The medium of claim 20, wherein at least one processor platforms include a separate processor platform, wherein the binary file include an application resource designed for the processor platform and a separate application resource designed for the separate processor platform and wherein the post-link operations include a thinning operation to remove the separate executable code.

22. The medium of claim 13, wherein storing the intermediate code comprises:
certifying the intermediate code with a signed certificate, the signed certification to ensure that the intermediate code has not been modified when received at the server device.

23. The medium of claim 13, wherein the intermediate code is received from a developer device, wherein the intermediate code includes symbols obfuscated from the source code, wherein the symbols and information of the source code are related via a mapping data for debugging the source code, further comprising:
generating debug information based on the symbols in the intermediate code and the mapping data; and
sending the debug information to the developer device for bug reporting.

24. A computer implemented method comprising:
generating, at a first device, a compiled code from a source code specifying data processing operations using one or more build options, the compiled code including executable code and intermediate code, wherein the one or more build options are embedded in the intermediate code; and
sending the intermediate code to a second device remotely coupled to the first device, wherein the source code and the executable code are not sent to the second device, wherein a plurality of executable codes targeting a plurality of processor platforms can be generated from the intermediate code using the one or more build options, each executable code to perform the data processing operations specified in the source code, and wherein the source code is hidden from the intermediate code.

25. A computer system comprising:
a memory storing instructions; and
a processor coupled to the memory to execute the instructions from the memory, the processor being configured to
store, in response to receiving an intermediate code, the intermediate code in a storage coupled to the processor, wherein the intermediate code and an executable code were previously generated from a source code using one or more build options that are embedded in the intermediate code, the executable code targeting a processor platform to perform data processing operations specified in the source code,
generate a particular executable code from the intermediate code targeting a particular processor platform, the particular executable code to perform the data processing operations in the particular processor platform, the particular executable code generated according to the build options embedded in the intermediate code, and
in response to a request for software to perform the data processing operations from a device of the particular processor platform, sending the particular executable code to the device.
